(19) United States
(12) Patent Application Publication
(10) Pub. No.: US 2013/0033046 A1
(43) Pub. Date: Feb. 7, 2013

(54) DOOR LOCKING / SECURITY DEVICE

(71) Applicant: Daniel V. Regan, Katy, TX (US)

(72) Inventor: Daniel V. Regan, Katy, TX (US)

(21) Appl. No.: 13/564,683

(22) Filed: Aug. 1, 2012

Related U.S. Application Data
(60) Provisional application No. 61/515,264, filed on Aug. 4, 2011.

(51) Int. Cl. E05C 19/00

(52) U.S. Cl. 292/338

(57) ABSTRACT

A Door Locking/Securing Device comprised of Two Separate Machined Steel pieces including a Bracket and a Removable Insert. The Bracket which Fits in the Clearance between the edge of the Door and Door Jamb is Secured to the Door Jamb so that projections extend into the Room into which the Door opens. The removable insert fits onto the projection of the Bracket when the door is closed preventing the Door from being opened. This forms a highly effective barrier preventing the forced opening of the Door from the exterior.

### REFERENCES CITED

### US Patent Documents

| | | | |
|---|---|---|---|
| 794,400 | July 1905 | Farrell | 292/292 |
| 866,548 | September 1907 | Wilkinson | 292/292 |
| 939,785 | November 1909 | Auger | 292/292 |
| 1,043,549 | November 1912 | Stevenson | 292/292 |
| 1,288,988 | December 1918 | Reed | 292/292 |
| 1,971,440 | April 1933 | Aubertin | 292/292 |
| 4,204,708 | May 1980 | Carlson | 292/218 |
| 5,480,200 | January 1996 | Aintablian | 292/288 |
| 5,772,265 | June 1998 | Gilbert | 292/207 |

### DESCRIPTION

### Summary of the Invention

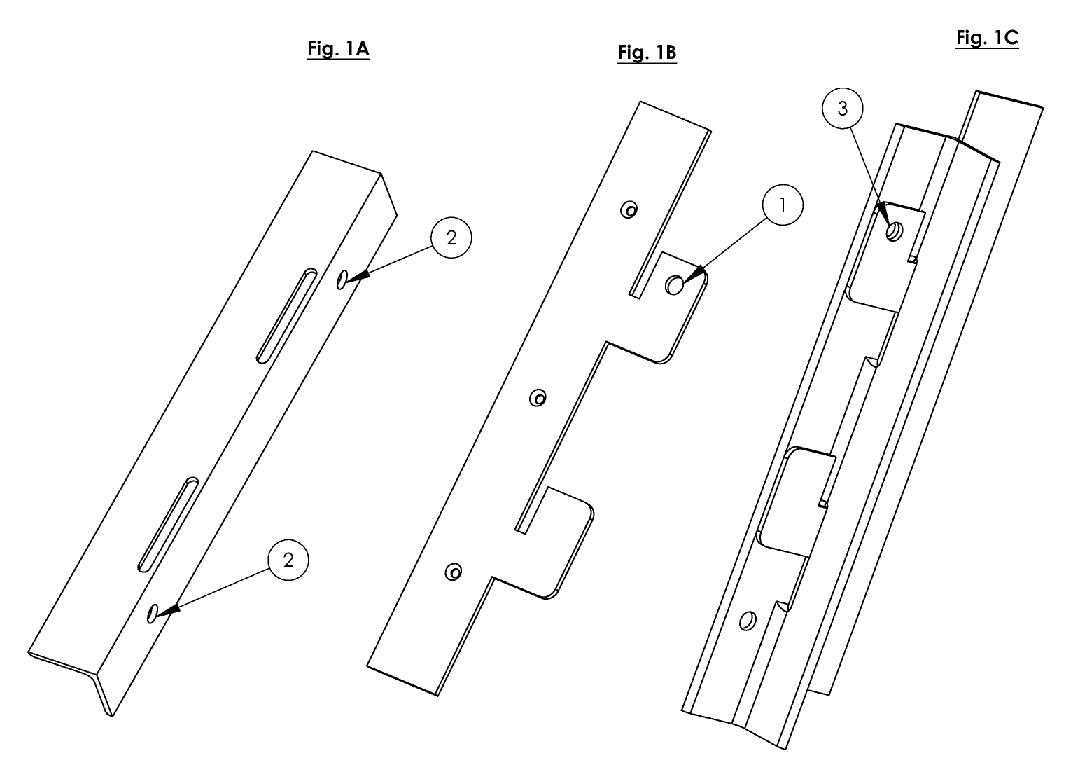

A Flat Steel Bracket (FIG. 1B) is mechanically fixed with three Screws to the inner face of the Door Frame. The screws should pass through the Door Frame and into the Door Frame Studs. The Bracket is mounted so that the two Projections Face Outward in the Direction of the Door Swing with Slots in the Projections Facing Upward (as shown in FIG. 1B).

The “Insert” (FIG. 1A) is made from a piece of 90 Degree Steel Angle. It has two machined slots that allow it to be assembled to the projections on the “Bracket”.

When the Door is closed the “ Insert” is Assembled to the “ Bracket” (FIG. 1C) by mating the Projections of the Bracket to the Slots of the Insert and allowing the Insert to fall into or mesh with the Slots Behind the Projections of the Bracket. When assembled in this manner the Insert extends beyond the face of the Door and acts as a Barrier, Preventing the Door from Opening.

The Upper Projections of the Bracket has a centered Hole (Detail 1) which corresponds to the Hole in the Insert (Detail 2). When both Holes are assembled in place (Detail 3) a padlock can be placed through the Holes to prevent removal of the insert. There are two Holes pictured on the Insert (Detail 2). The hole to be used is determined by which side of the door facing the bracket is mounted on.

This is a Non-Provisional Patent Application of Provisional Application No. 61/515,264 Originally Filed On Aug. 4, 2011

### DETAILED DESCRIPTION OF THE DRAWING

The Individual Pieces that comprise the Door Barrier can be seen in the drawing.

The Insert=FIG. 1A The Bracket=FIG. 1B

The two Pieces are shown as assembled in FIG. 1C.

The Hole=Detail 1 and Detail 2 Both Holes assembled=Detail 3

What is claimed is:

1. A Door Locking/Securing Device Comprised of Two Separate Pieces of Machined Steel. A Bracket which fits in the Clearance between the edge of the Door and the Door Jamb and is Secured to the Door Jamb by screws through three Holes in the Bracket allows two slotted Projections of the Bracket Facing Upward to extend into the room into which the door opens. And when the Door is Closed, a Removable Insert Fabricated from a Piece of 90 degree Angle Steel with two Machined Slots that correspond to the Slotted Projections of the Bracket.

2. When the Door Is Closed and the Parts (claim 1) are Assembled or Mated together placing the two Slots of the Removable Insert to Mesh with the Slots Behind the Bracket Projections, The Door Barrier Is Activated.

3. This will provide a Strong Prevention of Forced entry of a Door Unless the Insert is Lifted from the Bracket Projections by a person on the Interior side of the Door.
